(19) United States
(12) Patent Application Publication
(10) Pub. No.: US 2003/0042357 A1
(43) Pub. Date: Mar. 6, 2003

(54) Transmission system

(76) Inventor: Dale E. Van Cor, Winchester, NH (US)

Correspondence Address: Lawson, Philpot & Persson, P.C., Suite 110, 67 Water Street, Laconia, NH, 03246, US

(21) Appl. No.: 10/231,685

(22) Filed: Aug. 30, 2002

Related U.S. Application Data
(60) Provisional application No. 60/316,384, filed on Aug. 31, 2001.

(51) Int. Cl. B64D 35/00

(52) U.S. Cl. 244/60

(57) ABSTRACT

A transmission system for an aircraft that include a first geared member having a plurality of teeth arranged about its outside surface to form at least one acceleration channel and at least one deceleration channel. At least one mating geared member is dimensioned to mate with the first geared member such that rotation of the mating geared member causes the first geared member to rotate. An input shaft rotationally couples one of the mating geared member and the first geared member to a source of rotation and an output shaft rotationally couples other. The first geared member is dimensioned to interact with said mating geared member in such a way as to vary a speed of rotation of said output shaft without a corresponding change in a speed of rotation of said input shaft.

### CLAIM OF PRIORITY

This application claims the benefit of priority under Title 35, United States Code §119(e), of U.S. Provisional Patent Application Serial No. 60/316,384, filed Aug. 31, 2001.

### FIELD OF THE INVENTION

The present invention relates to the field of transmissions and, in particular, to an improved transmission system utilizing the applicant's VCT cone or VCT2 stack of gears for transmitting power to an aircraft rotor.

### BACKGROUND OF THE INVENTION

The applicant is the inventor of two related and co-pending applications, which each disclose arrangements of gears and systems utilizing these arrangements. U.S. patent application Ser. No. 09/734,407, incorporated herein by reference, discloses and claims a gear train and transmission system called the VCT, while U.S. patent application Ser. No. 09/891,226, also incorporated herein by reference, discloses and claims a stack of gears and transmission system called the VCT2.

The VCT transmission system includes a pinion gear having a plurality of helical teeth. A cone is disposed in contact with the pinion gear and includes a plurality of conic teeth and a plurality of scaling teeth. The conic teeth are arranged about the cone to form a plurality of conic rings disposed about a plurality of nascention circles on the cone. The conic teeth of the conic rings are dimensioned to mate with the helical teeth of the pinion gear such that the conic teeth neutralize a change in surface speed of the cone along the conic teeth. The scaling teeth form at least one acceleration channel and at least one deceleration channel extending from each of the conic rings and intercepting an adjacent conic ring and the acceleration channel and deceleration channel are disposed along a nascention offset line between nascention circles of adjacent conic rings.

The VCT2 utilizes a stack of gears, which includes and a second gear disposed in parallel relation to, and sharing a common axis with, the first gear. Each gear is of a different diameter and each includes a plurality of teeth. At least one transition train of teeth is disposed between the first gear and the second gear. Like the first and second gear, the transition train also includes a plurality of teeth that are disposed in substantially perpendicular relation to the common axis. The transition train is dimensioned to form at least one deceleration channel and at least one acceleration channel extending from each of the first gear and the second gear. The VCT2 transmission system also includes a mating member dimensioned to mate with the first plurality of teeth, the second plurality of teeth, and the third plurality of teeth of the stack of gears. In some embodiments, this mating member is a pinion gear, while in others it is a continuous loop drive, such as a chain, a toothed belt, a V-belt, or a flat belt drive.

In operation, the pinion gear or other mating member of either the VCT or VCT2 moves about a given conic ring or gear at a substantially constant speed until a higher or lower speed is desired. If a higher speed is desired, the mating member is moved into an acceleration channel, which allows the gear to move to a higher conic ring or gear. If a lower speed is desired, the mating member is moved into a deceleration channel, which allows the member to move to a lower conic ring or gear.

The VCT2 is fundamentally different from the VCT in six distinct ways. First, the axis of the pinion gear in the VCT2 is parallel with the axis of the stack of gears, where the VCT has the gear axis parallel to the face of the cone. Second, the conix formula does not apply, as the pinion gear can be a standard gear or any helical gear. Third, the VCT cone does not have to be a cone in the VCT2 , as the angle between the ring gears can be constant, varied or curved. Fourth, the embodiment of the VCT described in FIG. 62 of the '407 application will not work with the VCT2 , as the shaft the pinion gear is on is for controlling the position of the gear. Fifth, the VCT Felch cascade configuration will not work with the VCT2 because the cone cannot move independently and lateral movement of the inner and outer shaft would be unworkable. Sixth, the Persson configuration of the VCT2 , will not work with the VCT because the axes of all gears are parallel to each other.

The VCT2 is also similar to the VCT in many ways. For example, vector loading of the VCT applies directly to embodiments of the VCT2 where the first and second gears are helical gears, as these can still experience sideways pressure to move to a higher or lower gear range due to the vectoral force applied to the helical surface. In such an embodiment, the stack of gears of the VCT2 may have different helical teeth based on the environment. For example, a high torque environment would require a smaller helical angle then the lower torque, so that it did not move to easily.

Another similarity is in the design of the acceleration and deceleration channels, as the lateral motion in each should be an S-curve. Further, as with many embodiments of the VCT, embodiments of the VCT2 have an entrance, acceleration and deceleration tube and an exit. The speed in the entrance is the speed of the departing ring gear and the speed of the exit is the speed of the arriving ring gear. The tube is where the speed changes on a fractional basis making the change in speed continuous as opposed to stepped.

Yet another similarity is that both follow the same footprint analysis when laying out the movement of pinion gear through the channels is very similar, with both the VCT and VCT2 being adaptable for use with a variety of alignment and control surfaces. Finally, as was the case with the VCT, the VCT2 may be utilized in a number of configurations. These may be grouped as cascading, planetary or differential.

One application of the VCT and VCT2 that shows significant promise is in the area of rotor control for rotary aircraft, such as helicopters. Current helicopter designs rely on a single, direct drive, system that relies upon variations in engine speed to vary the speed of the rotor. Because the power required for take-off is much higher than is required for level flight, current systems represent a compromise between these power levels. Accordingly, the speed at which the helicopter may take off is reduced, while the stresses and vibrations, and fuel economy, are compromised during level flight.

Another application of the VCT and VCT2 that shows significant promise is in the area of propeller control for turboprop aircraft. Current control systems for turboprop aircraft employ a feathering of blades to take up for differences in air densities at different altitudes. This feathering is, again, a compromise between power and efficiency. Therefore, a control system that will eliminate such a compromise is highly desirable.

### SUMMARY OF THE INVENTION

The present invention is a control system utilizing VCT or VCT2 systems, which overcomes the power and efficiency compromises found in current rotary aircraft. Embodiments of the VCT2 rotor control include a planetary system utilizing the Persson configuration of the VCT2 , while embodiments of the VCT rotor control include a Tatham planetary configuration of the VCT. Finally, some embodiments of the rotor control utilize worm drives using either VCT or VCT2 geared members.

In its most basic form, the transmission system includes a first geared member with an outside surface having a first end of a first diameter and a second end of a second diameter, and a plurality of teeth arranged about the outside surface to form at least one acceleration channel and at least one deceleration channel. At least one mating geared member is provided having an outside surface dimensioned to mate with the plurality of teeth arranged about the geared member such that rotation of the mating geared member causes the first geared member to rotate. An input shaft rotationally couples one of the mating geared member and the first geared member to a source of rotation, and an output shaft rotationally coupling the other. The first geared member is dimensioned to interact with the mating geared member in such a way as to vary a speed of rotation of the output shaft without a corresponding change in a speed of rotation of the input shaft.

In some embodiments, the first geared member is a VCT2 stack of gears, the mating geared member is an idler gear, and the input shaft is a splined input shaft. In these embodiments, a first power transfer gear rotationally engages and moves along the splined input shaft, and mates with and rotationally engages the idler gear. In addition, it is preferred that a direct drive gear train and a clutch for transferring control of the rotation from the direct drive gear train to the power transfer gear be provided in these embodiments. It is likewise preferred that a second idler gear and power transfer gear be provided and that the input shaft is a splined shaft coupled to one power transfer gear, while the output shaft is a splined shaft coupled to the other power transfer gear.

In other embodiments of the system, the first geared member is a VCT cone, the input shaft is a splined input shaft and the mating geared member is a first power transfer gear rotationally engaging and movable along the splined input shaft and dimensioned to mate with and rotationally engage the VCT cone. These embodiments also include a direct drive gear train, and a clutch for transferring control of the rotation from the direct drive gear train to the power transfer gear. It is likewise preferred that a second power transfer gear be provided and that the input shaft is a splined shaft coupled to one power transfer gear, while the output shaft is a splined shaft coupled to the other power transfer gear.

Finally, other embodiments are worm drive embodiments in which the first geared member is either a VCT cone or a VCT2 stack of gears. In these embodiments, the cone or stack rotationally engages and is movable along a splined output shaft and the mating geared member is worm gear disposed upon the input shaft. Finally, in embodiments utilizing a VCT2 stack of gears, a universal joint is in communication with the splined output shaft to adjust for variations in the angle of the splined shaft.

The components of a planetary system are traditionally a sun gear with planet gears around the sun, held in position by a ring gear. The Persson configuration is a unique application in that the sun gear is a stack-of-gears in a VCT2 . A planet gear is actually two gears, the idler and power transmission gear of the Persson cascade, which act as one unit. The ring is an idler ring gear used to hold the power transmission gears in place and even the distribution of the torque. The idler ring is not included in the rotor control because it may hamper the break away characteristics of the planets and add more components without significantly contributing to this application performance.

Embodiments of the control system utilizing a VCT2 Persson planetary system include a stack-of-gears, a power transfer gear, a power transfer splined shaft, an output idler gear, an input idler gear, an input shaft gear, an output shaft, input shaft, and a clutch. The power transfer components are from the input shaft gear to the input idler gear to the input gear, which is mounted on the power transfer splined shaft. The power transfer gear on the same splined shaft meshes with the output idler gear. This in turn meshes with the VCT2 stack of gears. With the clutch engaged, the torsion is through the stack of gears to the output shaft and the input idler gear is the same gear ratio as the output idler gear. To increase the gear ratio, the clutch is disengaged and the output idler gear is slid up to the next gear in the stack of gears. This process is repeated for higher gear ratios and reversed for lower gear ratios.

A second embodiment of the control system of the present invention utilizes a Tatham configuration of the VCT in a planetary system in which the outside ring is eliminated. This control system includes a VCT cone, a splined shaft, a power transfer gear, a splined shaft gear, an input shaft gear, a clutch, an input shaft and an output shaft. The power transfer components are from the input shaft gear to the splined shaft gear, which is mounted on the splined shaft, with the power transfer gear on the same splined shaft that meshes with the VCT cone. The input shaft gear and splined shaft gear are proportionally sized with the power transfer gear on the cone to ensure that both sides of the clutch have the same gear ratio. With the clutch engaged, the torsion is through the cone to the output shaft and the output speed of the power transfer gear to the cone is equal to the speed of the input shaft. To increase the gear ratio, the clutch is disengaged and the power transfer gears are slid up to the next conic gear position. The process is repeated for higher gear ratios and reversed for lower gear ratios.

The Persson and Tatham planetary systems described above are readily incorporated into configurations that are suited for the speed control of a rotor or propeller of a rotary aircraft. This speed control is an improvement over current designs as it allows the gear ratio to be optimized for maximum power for taking off, while reducing stresses, vibration and power consumption during lower powered level flight. The speed control of the present invention utilizes a redundant system in which the transmission is not effectively engaged at its lowest gear ratio. At take off, a clutch engages a direct drive, which may be designed to maximize thrust and allow for quicker take-off. Once airborne, the clutch is disengaged and the transmission is engaged, allowing the rotor to be shifted to a higher gear ratio Due to the nature of aircraft design, the clutch may also have emergency by-pass capacity so any catastrophic failure will result in resuming direct drive.

Therefore, it is an aspect of the present invention to provide a control system for an aircraft that allows for optimization of flight characteristics at different air densities, engine output, altitude and air speed.

It is a further aspect of the present invention to provide a control system for an aircraft that allows a lower gear ratio for the initial revolutions of the blades.

It is a further aspect of the present invention to provide a control system for an aircraft that allows higher take-off torque with a lower gear ratio.

It is a further aspect of the present invention to provide a control system for an aircraft that allows lower torque requirements at cruising altitude and speed.

It is a further aspect of the present invention to provide a control system for an aircraft that allows the engine to operate at a lower RPM relative to the rotation of the blades.

It is a further aspect of the present invention to provide a control system for an aircraft that produces less vibration and quieter flight with higher gear ratios.

It is a further aspect of the present invention to provide a control system for an aircraft that reduces maintenance costs by reducing wear and tear on the aircraft.

It is a further aspect of the present invention to provide a control system for an aircraft that provides increased fuel efficiency through optimization of engine output at a given rotor or propeller speed.

It is a still further aspect of the present invention to provide a control system for a turboprop aircraft that allows for optimization of the angle of attack on the blades.

These aspects of the invention are not meant to be exclusive and other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a top diagrammatic view of a Persson Planetary System.

FIG. 2 is a side diagrammatic view of the Persson Planetary System of FIG. 1.

FIG. 3 is a top diagrammatic view of a Persson Planetary System of FIG. 1 moved to a different gear ratio with the idler gears and power transfer gear all in a line.

FIG. 4 is a side diagrammatic view of the Persson Planetary System of FIG. 3.

FIG. 5 is a top diagrammatic view of a Persson Planetary System with dual cascading idler gears.

FIG. 6 is a side diagrammatic view of the Persson Planetary System of FIG. 5.

FIG. 7 is a top diagrammatic view of the Persson Planetary System of FIG. 5 moved to a different gear ratio.

FIG. 8 is a side diagrammatic view of the Persson Planetary System of FIG. 7.

FIG. 9 is a side view of the VCT2 rotor control in engaged with a first gear.

FIG. 10 is a top view the VCT2 rotor control of FIG. 9.

FIG. 11 is a top view of the VCT2 rotor control in engaged with a second gear.

FIG. 12 is a side view the VCT2 rotor control of FIG. 11.

FIG. 13 is a top view of the VCT2 rotor control in engaged with a third gear.

FIG. 14 is a side view the VCT2 rotor control of FIG. 13.

FIG. 15 is a top view of the VCT2 rotor control in engaged with a fourth gear.

FIG. 16 is a side view the VCT2 rotor control of FIG. 15.

FIG. 17 is a side view of a VCT rotor control in engaged with a first conic ring.

FIG. 18 is a side view of the VCT rotor control of FIG. 17 engaged with a second conic ring.

FIG. 19 is a side view of the VCT rotor control of FIG. 17 engaged with a third conic ring.

FIG. 20 is a side view of the VCT rotor control of FIG. 17 engaged with a fourth conic ring.

FIG. 21 is a side view of a helicopter having a main rotor transmission and a tail rotor transmission.

FIG. 22 is top view of FIG. 21

FIG. 23A is a side view of a VCT worm gear set of the present invention in which the VCT cone is at a first position on a splined shaft.

FIG. 23B is a side view of the VCT worm gear set of FIG. 23A in which the VCT cone is at a second position on a splined shaft.

FIG. 23C is a side view of the VCT worm gear set of FIG. 23A in which the VCT cone is at a third position on a splined shaft.

FIG. 24A is a cross-sectioned front view of a worm gear and a worm.

FIG. 24B is a side view of FIG. 24A.

FIGS. 25A is a side view of a VCT2 stacked worm drive of the present invention in which the stack is at a first position on a splined shaft.

FIG. 25B is a side view of the VCT2 stacked worm drive of FIG. 25A in which the VCT cone is at a second position on a splined shaft.

FIG. 25C is a side view of the VCT2 stacked worm drive of FIG. 25A in which the VCT cone is at a third position on a splined shaft.

FIGS. 26A-H are diagrammatic views showing a worm passing by an entrance.

FIGS. 27A-H are diagrammatic views of a worm moving out of a worm gear and into a transition channel entrance.

### DETAILED DESCRIPTION OF THE INVENTION

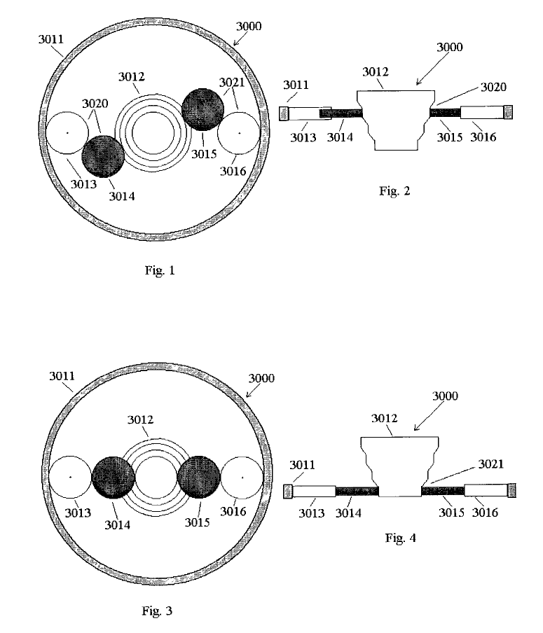

Referring first to FIGS. 1 and 2, top and side views of a Persson planetary system are shown. In this system 3000, the stack-of-gears 3012 is in the middle. A first planet unit 3020 consists of a power transfer gear 3013 and an idler gear 3014. The second planet unit 3021 is 3015 and 3016. Both plant units 3021, 3021 are in contact with the idler ring gear 3011 and the stack of gears 3012. The idler gears 3014 and 3015 move laterally as they go to different locations. In FIGS. 3 and 4, the stack of gears 3012 idler gears 3014 and 3015 and power transfer gears 3013 and 3016 all in a line, and the gears are engaged with at the bottom gear 3021 of the stack of gears 3012. Conversely, in FIGS. 1 & 2, the gears 3013, 3014, 3015 and 3016 are engaged with a middle gear 3020 of the stack of gears 3012 and, therefore, the idler gears 3014 and 3015 are moved laterally to allow for this contact with a larger gear 3020 in the stack 3012.

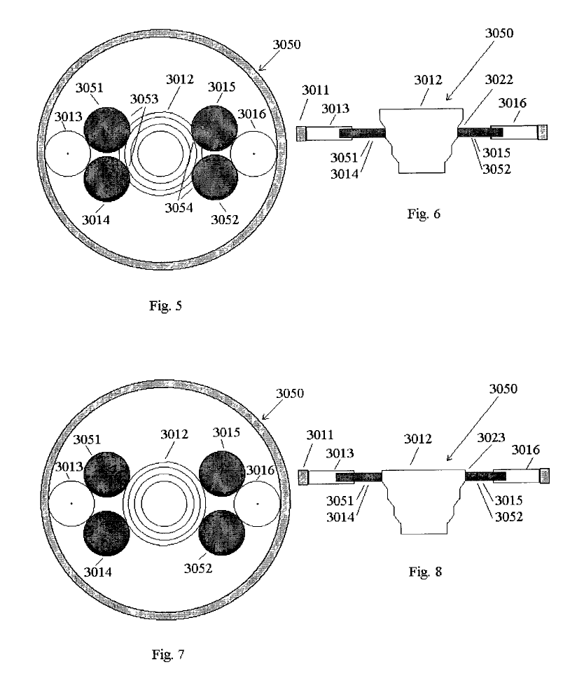

FIGS. 5-8 show a Persson Planetary System 3050 with dual cascading idler gears 3053 and 3054. The concept of the cascade is that more torque can be transmitted through smaller teeth then the single cascade. FIGS. 5-8 demonstrates that as long as the dual cascading gears 3051 and 3014 have room to separate and stay in contract with the stack 3012 and power transfer gear 3013 they can go to a higher gear ratio 3022 and 3023. It is noted that the embodiment of FIGS. 1-4 would not have enough room for dual cascading gears.

The strength of a planetary system is that it can transmit more torque then a cascading system with the same size teeth because it has more gears. The Persson Planetary System can transmit torque to the ring gear 3011 or to its power transfer gears 3013, 3016. Further, the power transfer gears 3013, 3016 can be on a planet carrier (not shown).

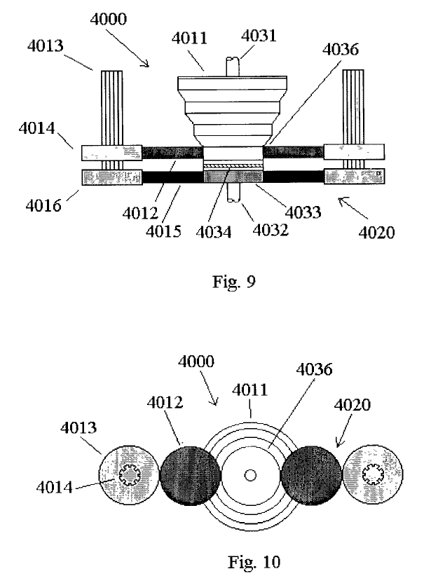

As shown in FIG. 9, the VCT Rotor Control 4000 is a VCT2 Persson Planetary System with the idler ring omitted. The rotor control 4000 includes a stack-of-gears 4011, a power transfer gear 4014, a power transfer splined shaft 4013, an output idler gear 4012 and an input idler gear 4015, and an input gear 4016. As shown in the cross sectional view of FIG. 9, the rotor control 4000 also has an output shaft 4031, input shaft 4032, input gear 4033, and a clutch 4034.

The power transfer components 4020 are from the input shaft gear 4032 to the input idler gear 4015 to the input gear 4016, which is mounted on the power transfer splined shaft 4013. The power transfer gear 4014 on the same splined shaft 4013 meshes with the output idler gear 4012. This in turn meshes with the VCT2 stack of gears 4011. In the embodiment of FIG. 9, the clutch 4034 is shown in an engaged position and the output idler gear 4012 and input idler gear 4015 are at the same gear ratio. With the clutch 4034 engaged, the torsion is through the stack of gears 4011 to the output shaft 4031.

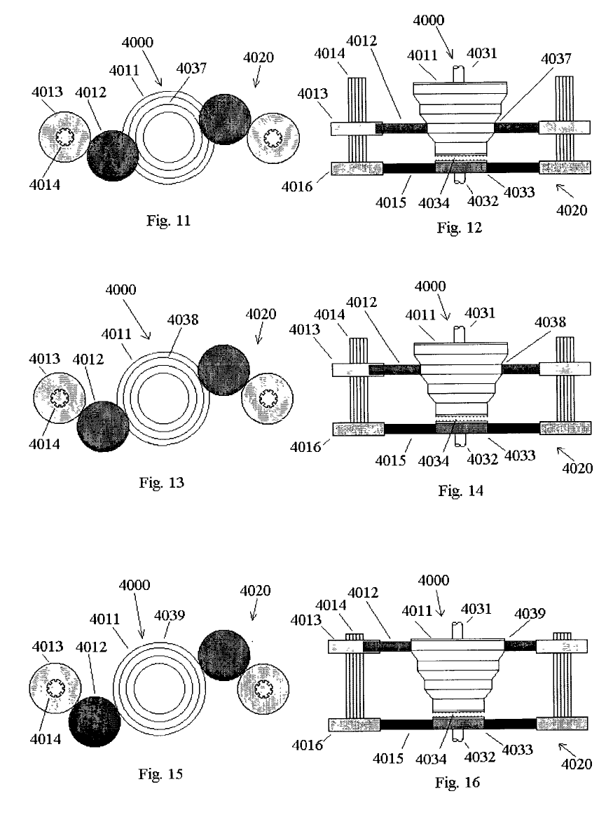

FIGS. 11-16 are diagrams on side views and cross sections demonstrating the changes in the output idler gear 4012 and the clutch 4034. As noted above, in FIGS. 9-10, the clutch is engaged and the input idler gear 4015 is the same gear ratio as the output idler gear 4012 at position 4036. To increase the gear ratio, as shown in FIGS. 11-12, the clutch 4034 is disengaged and the output idler gear 4012 is slid up to the next gear 4037 in the stack of gears 4011. This process is repeated in FIGS. 13-16 for higher gear ratios at positions 4038 and 4039.

The Persson Planetary System allows for the development of breakaway brackets so the output idler 4012 can break free of the stack of gears if the transmission is under undue stress. An emergency operation would be for the clutch 4034 to be engaged and the output idler 4012 to be disengaged in one operation. The input 4032 and output shafts 4031 would not be at the same speed and the clutch would have to absorb this by slipping until the energies are balanced.

The stack of gears 4011 and the input shaft gear 4032 would have shear pins on its shaft mounting. If the shear pins were sheared, then the clutch would automatically engage. Another emergency mechanism would be to choose to shear both pins and engage the clutch or have a retractable locking mechanism that would effectively by-pass the transmission inside the cone.

The effect of this device is to give a direct drive, full power take-off capacity of a helicopter, while providing a more economical, lower vibration, quieter cruising speed. In the event of any catastrophe, the transmission can “break away” or be by-passed so the system will always fall back to the direct drive mode.

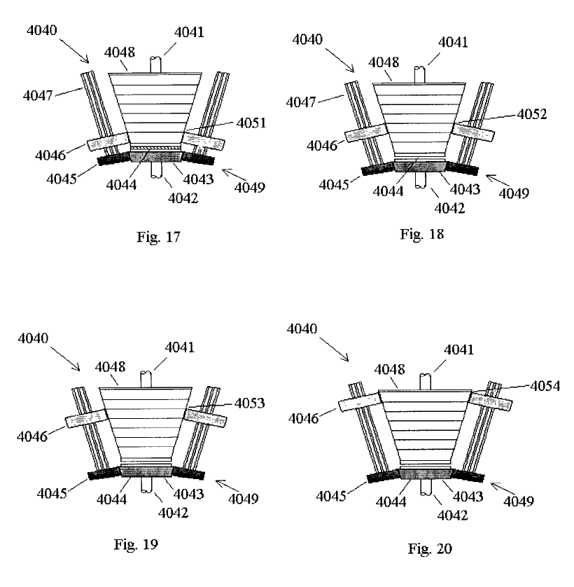

A second rotor control configuration is a VCT Rotor Control 4040, which is shown in FIGS. 17-20. This rotor control 4040 utilizes a VCT Tatham Planetary System without the outside ring, and includes a VCT cone 4048, a splined shaft 4047, a power transfer gear 4046, a splined shaft gear 4045, a clutch 4044, an input shaft gear 4043, an input shaft 4042 and an output shaft 4041.

The power transfer components 4049 are from the input shaft gear 4043 to the splined shaft gear 4045, which is mounted on the splined shaft 4047. The power transfer gear 4046 on the same splined shaft meshes with VCT cone 4048. In the embodiment of FIG. 17, the clutch 4044 is shown in an engaged position. The input shaft gear 4043 and splined shaft gear 4045 are proportionally sized with the power transfer gear 4046 in position 4051 on the cone 4048 to ensure that both sides of the clutch have the same gear ratio. With the clutch engaged, the torsion is through the cone 4048 to the output shaft 4041.

Referring again to FIGS. 17-20, the changes in the power transfer gear 4046 and the clutch 4044 are demonstrated. Starting with FIG. 17, the clutch 4044 is engaged and the output speed of the power transfer gear 4046 to the cone 4048 is equal to the speed of the input shaft 4042. To increase the gear ratio, as shown FIG. 18, the clutch 4044 is disengaged and the power transfer gears are slide up to the next conic gear at position 4052. The process is repeated in FIGS. 19-20 for higher gear ratios at positions 4053 and 4054.

The Tatham Planetary System allows for the development of breakaway brackets so the splined shaft 4047, power transfer gear 4046 and splined shaft input gear 4045 can break free of the cone 4048 if the transmission is under undue stress. An emergency operation would be for the clutch to be engaged and the splined shaft assembly withdrawn in one operation. The input and output shafts would not necessarily be at the same speed and the clutch would have to absorb this by slipping until the energies are balanced.

The input shaft gear 4044 would have a shear pins on its shaft mounting. If the shear pins were sheared, then the clutch would automatically engage. Anther emergency mechanism would be to have a retractable locking mechanism that would effectively bypass the transmission inside the cone. This second clutching system not shown would be a direct drive through the center of the cone.

As was the case with the VCT2 rotor control, the effect of the VCT rotor control is to give a direct drive, full power take-off capacity of a helicopter while providing a more economical, lower vibration, quieter cruising speed. In the event of any catastrophe, the transmission can “break away” or be by-passed so the system will always fall back to the direct drive mode.

The VCT and VCT2 rotor controls shown have had the direct drive be the lowest gear ratios. However, it is recognized that either may be designed to have more gears at a lower gear ratio then the direct drive position. For example, the initial starting of the helicopter blades would faster if it had a lower gear ratio. If a transmission is already in place, this is a small addition. Quicker starts may have some emergency or military applications.

For a turboprop application, the gear ratio can be increased with the increase altitude and speed. The feather blade would have a larger “screw” with thinner air and higher speed. The thicker air would require a smaller “screw” that the blade has to cut. Currently, the blades are feathered for different altitudes. A VCT rotor control would add optimization of the angle of attack to the feathering of the blades.

Another helicopter application of the Van Cor Transmissions is an anti-torque tail rotor, which stabilizes the direction of the helicopter by balancing the torque of the main rotor with a lateral airflow. In these applications, steering is achieved by feathering the blades of the tail rotor to increase or decrease this airflow. As the engine feed to the tail rotor is overcharged, there is a reserve that can be applied for steering, and the steering requirements can be adjusted with a VCT or VCT2 for different air densities and operating requirements. For example, at straight level flight the tail rotor feed can be at its minimum. At slower speeds, it can be increased for greater maneuvering. There can also be adjustments to allow for a high-speed maneuvering mode. Further, in embodiments in which the main rotor also has a VCT or VCT2 , changes in the main rotor output are balanced to the tail rotor feed, with the lower gear ratios for take-off verses the higher gear ratios of level flight.

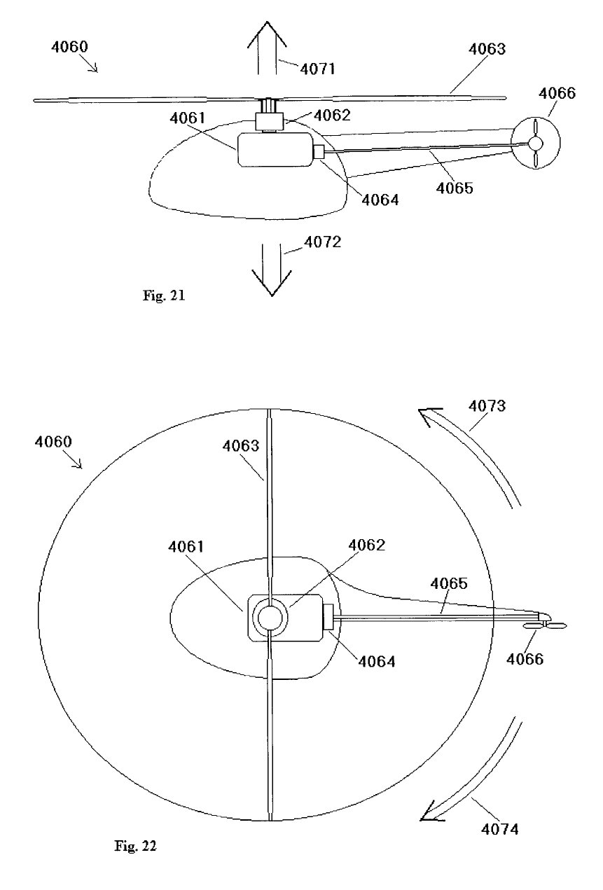

FIG. 21 is a diagram of a side view of a helicopter 4060. FIG. 22 is top view of FIG. 21. The diagram has an engine 4061, the Main Rotor Transmission (MRT) 4062 and the main rotor blades 4063. The tail rotor 4066 has a tail rotor drive shaft 4065 connected to a Tail Rotor Transmission (TRT) 4064.

When the VCT is applied to the MTR 4062 and/or the TRT 4064, it performs as an anti-torsion component in three ways. The first is to change the speed of the drive shaft 4065 of the tail rotor 4055. By increasing the rotation of the rotor relative to the rotation of the main rotor blades 4063 the helicopter is caused to rotate on its axis in either direction 4073,4074. This change in the rotor speeds mimics the feathering of the tail rotor blades by simply increasing or decreasing the anti-torsional airflow and, when used in conjunction with the feathering of the rotor blades, increases its impact.

The second is a rapid change in the speed of the tail rotor drive shaft, which changes the torsional relationship with the main rotor and results in the rotation of the helicopter on its' axis. The number of gear ratios and how quickly they change determine the speed with which the helicopter will rotate on its axis, with gyroscopic forces generated with the rotation of the main rotor be “tapped” with the TRT to induce rotational or counter rotational force relative to the more constant main rotor. To control a change in position, there is a sudden increase in gear ratio of the TRT that induces rotation, and then a sudden decrease to stop this rotation. This generates rotational momentum that will have to be countered to stop its rotation, which may be done by a short change in the counter direction by the TRT. It is also possible to design the blades of the anti-torque tail rotor to be at its most efficient pitch and control the rotational position of the tail with the TRT. Another way of thinking about this is that the tail rotor will not accelerate as quickly as the TRT output, so that additional acceleration induces the rotation of helicopter.

The third method of changing the position of the helicopter involves the use of sudden large changes in the TRT gear ratio and an equally timed change in the MRT gear ratio, which results will be a very fast change in position. In these embodiments, both the TRT and MRT change their gear ratios at the same time and direction, with the countering movement being relatively applied. The source of energy for these moves is gyroscopic force of the main rotor resistance and engine output.

These three uses of anti-torsion to control position, made possible by the continuous application of power inherent if the VCT, increase the helicopters efficiency when applied to the MRT and TRT. In addition, the added maneuverability of the helicopter has advantages in any application requiring close ground support, such as medical evacuation, police work, fire and rescue, or the like.

One particularly advantageous application for this technology is in military helicopters. In these applications, a helicopter that can quickly turn 90 or 180 degrees can quickly bring weapons to bear on line-of-side targets and would have additional flight characteristics that can be developed into combat maneuvers. For example, if the change it MRT gear ratio is equally timed and in the opposite direction of the TRT, it will cancel the TRT out and the position of the helicopter stays the same. However, this causes an energy surge which, when coupled with a change the pitch of the blades on the main rotor, would cause the helicopter to quickly rise 4071 a few feet, or drop 4072 a few feet. This sudden change in altitude could allow a military helicopter to avoid being hit by a missile or allow commercial helicopters avoid a collision.

The use of the VCT family of transmissions in helicopter applications allows gear ratios to be changed very quickly, resulting in a far greater capacity to “fine-tune” positions. In some embodiments, the TRT has three or four speeds, with the smallest gear ratios tuned for the smallest position changes. The fine adjustment of position is accomplished by shifting the gears through a channel to a higher or lower gear ratio and then returning back to the starting gear ratio after so many revolutions. Upon returning to its starting position, the transmission may have to shift to an opposite gear ratio for a few revolutions to counter any accumulated momentum.

The control of position may be accomplished manually in a substantially analog manner, with the user holding a control button to holding the change in gear ratio longer before stopping. In other embodiments, the control may be hard coded to “cycle” through a specific number of degrees of rotation of the helicopter. For example, hitting one button could be a 1-degree change, while pressing it 3 times quickly causes the helicopter to rotate 3 degrees on its axis. This could cause the TRT to go through three times as many revolutions at a different gear ratio before returning to the starting position. Other buttons could be 5 degrees, 30 degrees and a complete 180-degree change in direction, or any combination between.

These controlling aspects can be though of as inherent if the VCT are applied to the MRT and TRT for increasing the helicopters efficiency. The VCT on the MRT would give more working control of close ground support such as fire fighting, rescue or ambulatory roles.

In addition to its use in helicopters, the present invention is also readily applicable to tilt rotor aircraft, where the lifting and forward propulsion are at different RPM. The typical desired output speed range of the tilt rotor is from 480 to 640 RPM, while helicopters are in the range of 200 RPM. In tilt rotor aircraft, and most helicopters, a turbine engine is used with worm-drive gear reduction with the feathering of the blades being used for thrust controls. This process is extremely inefficient and, like the helicopters discussed above, requires that compromises be made between take-off power and efficiency during level flight. In the system of the present invention, the VCT or VCT2 can be used as a variable worm drive in these applications, allowing higher blade speeds for take-off and landing and lower blades speeds for constant speed cursing. The net effect being less fuel and more efficient operation compared to feathering the blades.

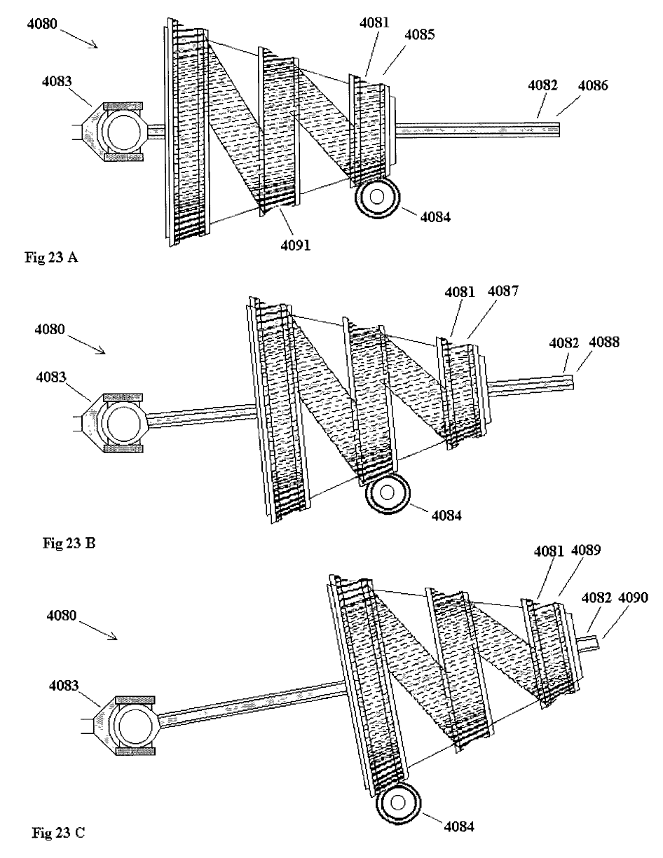

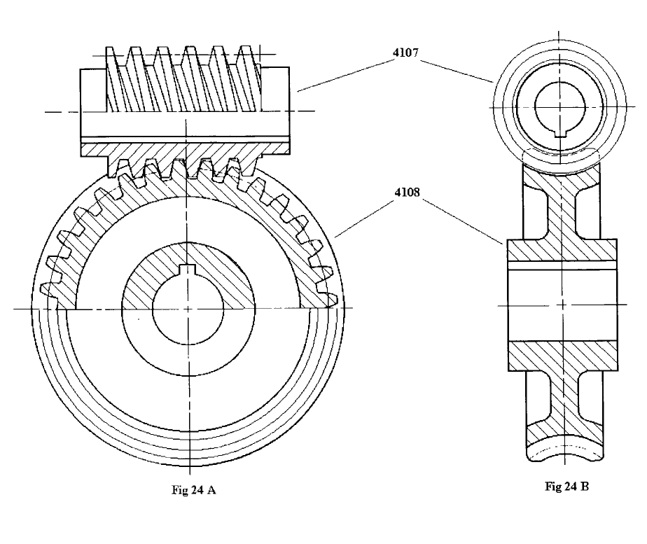

In tilt rotor applications, the VCT/VCT2 cone/stack act as the worm gears with a worm and a motion control system added to control the placement and position of the worm gears on the worm to make a variable worm drive. A worm has a rack profile and the worm gear has an involute profile. A diagram of a VCT worm gear set 4080 is shown in FIGS. 23 A-C with three conic worm gears with acceleration and deceleration channels between them making up a cone 4081. In FIG. 23A the VCT cone 4081 is on splined shaft 4082 with the output through the universal joint 4083 and the input through worm 4084.

In FIG. 23A, the cone 4081 is at position 4085 and the splined shaft 4082 is at position 4086. In FIG. 23-B, the cone 4081 has moved to position 4087 causing the splined shaft 4082 to incline to position 4088. During this process, the worm 4084 has maintained its position. In FIG. 23C the cone 4081 has moved to the extreme position 4089 and the splined shaft 4082 to inclined position 4090. Again, the worm 4084 has maintained its position.

The teeth on the conic gear are conic worm gears. This differentiation is shown in the gear profile 4091, which shows the curvature of the throat that is characteristic of a worm gear. The conic teeth are the same design as those of the VCT with the throat added so the worm gear can mesh with the conic gear a deeply as possible, extending the surface contact area.

A typical worm gear can be seen in FIG. 24A. This shows a cross-section of the worm gear 4108 in mesh with a worm 4107. In FIG. 24B there is a cross-sectioned side view of FIG. 24A that demonstrates the curved throat of the worm gear 4108 in mesh with the worm thread 4107.

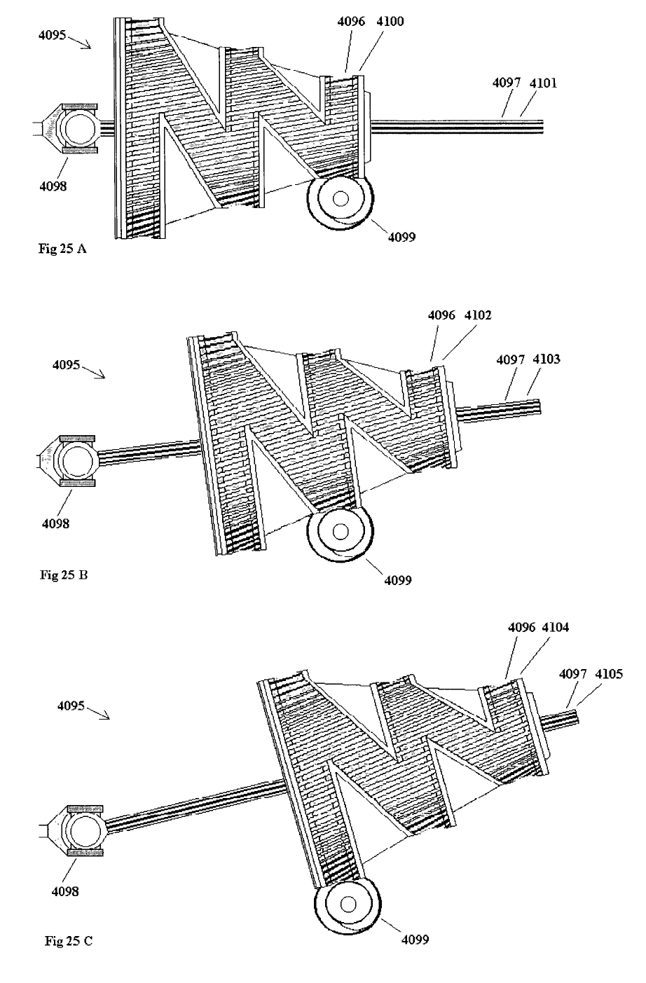

The VCT2 version of the system using stacked worm gears is very similar to the VCT version. The VCT2 will allow for a more dramatic change in speeds then the VCT. Normally, a VCT2 will have a transfer gear between two stacks. However, this is not necessary in the worm drive version, as the worm stack of gears has a transition worm gear between the stacked members, with the stack moving rather than the worm. This is a distinct difference between this system and the preferred VCT2 gear version, where the gear moves rather than the stack. A three-speed embodiment of a VCT2 stack worm drive system 4095 is shown in FIGS. 25A-C.

As shown in FIG. 25A, the system 4095 includes a stack 4096, a splined shaft 4097, a universal joint output 4098 and a worm input 4099. The stack 4096 is at position 4100 and the splined shaft 4097 is at position 4101. In FIG. 25B 4095, the stack 4096 has changed to position 4102 and the splined shaft 4097 has inclined to position 4103. The input worm 4099 has remained stationary, but the output speed has changed because it is now on a different worm gear. In FIG. 25C 4095, the cone 4096 has moved to extreme position 4104 and the splined shaft 4097 has inclined to 4105.

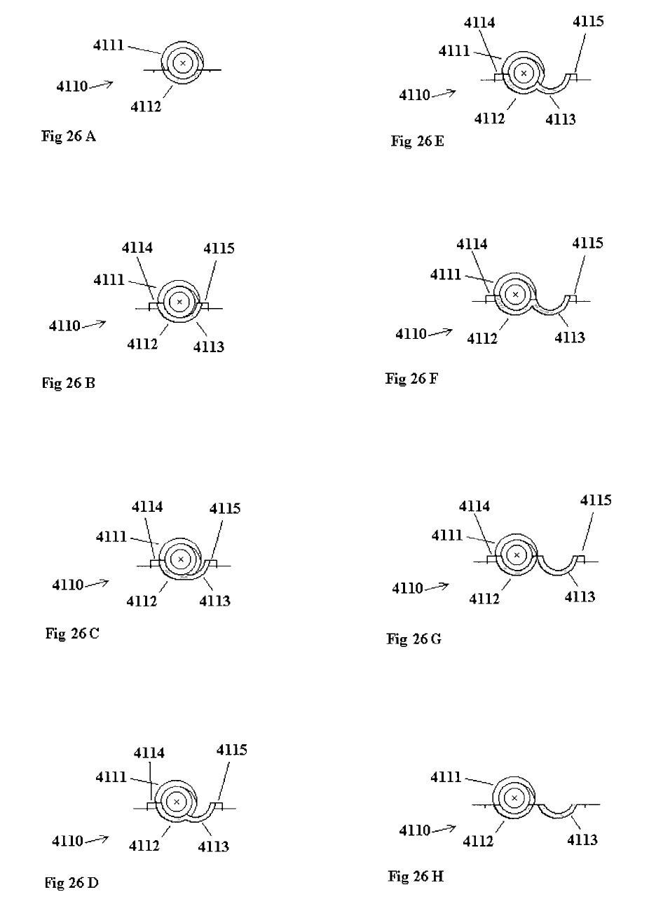

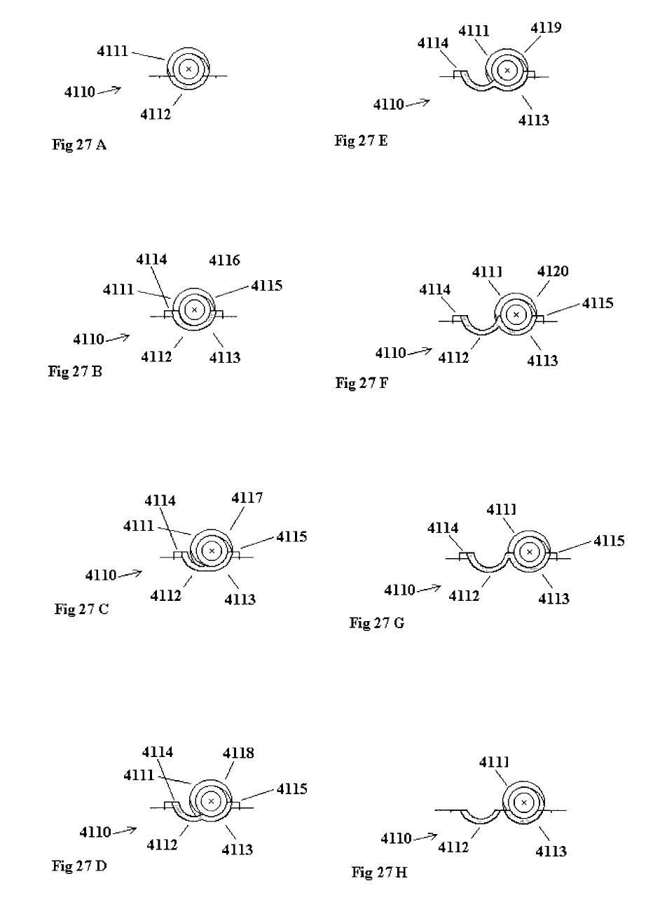

The meshing of the worm with either conic or stacked worm gears is demonstrated in FIGS. 26A-H, which is show a worm passing by an entrance, and FIGS. 27A-H, which show the worm 4111 moving out of the gear 4112 and into the transition channel entrance 4113. As demonstrated by these drawing figures, the way in which the worm gears and conic worm gears overlap with their acceleration and deceleration channels entrance and exits are very similar.

As shown in FIG. 26A, the worm 4111 is engaged with a worm gear 4112. In FIG. 26B, the worm is approaching a channel entrance 4113. Both sides of the worm gear 4112 rise up to 4114, 4115. This increases the surface area for the worm 4111 to engage in. In FIG. 26C 4110, the channel entrance 4113 expands reducing the surface contact area of the worm 4111 with the worm gear 4112. The additional sides 4114 compensate for this loss. The other FIGS. 26D-H dramatize the change in the cross section as the channel entrance 4113 splits off into a separate entity by FIG. 26H. Then the raised sides 4114,4115 are no longer necessary.

FIGS. 27A-H show the same cross sections, but the worm 4111 appears to move into the channel entrance 4113. In actuality, the cone/stack is moving and the worm is staying still. The worm gear 4112 has the sides raised in 4114,4115 starting in FIG. 27B and ending in FIG. 27G. The worm gears position appears to move from 4116 in FIG. 27B, to 4117 in FIG. 27C, to 4118 in FIG. 27D and to 4119 in FIG. 27E. By 4120 in FIG. 27F most of the surface contact between the channel 4113 and the worm 4111 has recovered. Positions 4121 in FIG. 27G and 4120 FIG. 27H clear the worm form the worm gear and is now in the channel acceleration/deceleration tube component where is will change speeds.

The incremental cross section of the passage of the worm gear past the channel entrance in FIGS. 26A-H displayed a reduction in the contact surface of the worm gear with the worm, which may be partially compensated for by raising the “sides” 4114, 4115 of the worm gear. The entering the channel entrance as displayed in FIGS. 27A-H shows the same surface reduction and how it was compensated for by sizing the space between the channel entrances and the worm gear/conic worm gear allow the worm freedom to relatively move or stay on the same path

Although the present invention has been described in considerable detail with reference to certain preferred versions thereof, other versions would be readily apparent to those of ordinary skill in the art. Therefore, the spirit and scope of the invention should not be limited to the description of the preferred versions contained herein.

What is claimed is:

1. A transmission system for an aircraft having at least one rotor, said system comprising:
a first geared member comprising an outside surface having a first end of a first diameter and a second end of a second diameter, and a plurality of teeth arranged about said outside surface to form at least one acceleration channel and at least one deceleration channel;
at least one mating geared member having an outside surface dimensioned to mate with said plurality of teeth arranged about said geared member such that rotation of said mating geared member causes said first geared member to rotate;
an input shaft rotationally coupling one of said mating geared member and said first geared member to a source of rotation; and
an output shaft rotationally coupling another of said mating geared member and said first geared member to said at least one rotor;
wherein said first geared member is dimensioned to interact with said mating geared member in such a way as to vary a speed of rotation of said output shaft without a corresponding change in a speed of rotation of said input shaft.

2. The transmission system as claimed in claim 1:
wherein said first geared member comprises a VCT2 stack of gears;
wherein said at least one mating geared member comprises at least one idler gear;
wherein said input shaft is a splined input shaft; and
wherein said transmission system further comprises;
a first power transfer gear rotationally engaging and movable along said splined input shaft, said first power transfer gear being dimensioned to mate with and rotationally engage said idler gear;
a direct drive gear train; and
a clutch for transferring control of said rotation from said direct drive gear train to said power transfer gear.

3. The transmission system as claimed in claim 2:
wherein said at least one idler gear comprises a first idler gear and a second idler gear;
wherein said first idler gear is dimensioned to mate with and rotationally engage said stack of gears and said first power transfer gear;
wherein said output shaft is a splined output shaft; and
wherein said transmission system further comprises a second power transfer gear rotationally engaging and movable along said splined input shaft and dimensioned to mate with and rotationally engage said second idler gear.

4. The transmission system as claimed in claim 1:
wherein said first geared member comprises a VCT cone;
wherein said input shaft is a splined input shaft;
wherein said at least one mating geared member comprises a first power transfer gear rotationally engaging and movable along said splined input shaft, said first power transfer gear being dimensioned to mate with and rotationally engage said VCT cone; and
wherein said transmission system further comprises a direct drive gear train, and a clutch for transferring control of said rotation from said direct drive gear train to said power transfer gear.

5. The transmission system as claimed in claim 4:
wherein said output shaft is a splined output shaft; and
wherein said at least one mating geared member comprises a second power transfer gear rotationally engaging and movable along said splined input shaft, said second power transfer gear being dimensioned to mate with and rotationally engage said VCT cone.

6. The transmission system as claimed in claim 1:
wherein said output shaft is a splined output shaft;
wherein said first geared member comprises a VCT2 stack of gears rotationally engaging and movable along said splined output shaft;
wherein said at least one mating geared member comprises a worm gear disposed upon said input shaft; and
wherein said transmission system further comprises a universal joint in communication with said splined output shaft.

7. The transmission system as claimed in claim 1:
wherein said output shaft is a splined output shaft;
wherein said first geared member comprises a VCT cone rotationally engaging and movable along said splined output shaft;
wherein said at least one mating geared member comprises a worm gear disposed upon said input shaft.

8. An aircraft comprising:
at least one rotor; and
at least one transmission system comprising:
a first geared member comprising an outside surface having a first end of a first diameter and a second end of a second diameter, and a plurality of teeth arranged about said outside surface to form at least one acceleration channel and at least one deceleration channel;
at least one mating geared member having an outside surface dimensioned to mate with said plurality of teeth arranged about said geared member such that rotation of said mating geared member causes said first geared member to rotate;
an input shaft rotationally coupling one of said mating geared member and said first geared member to a source of rotation; and
an output shaft rotationally coupling another of said mating geared member and said first geared member to said at least one rotor;
wherein said first geared member is dimensioned to interact with said mating geared member in such a way as to vary a speed of rotation of said output shaft without a corresponding change in a speed of rotation of said input shaft.

9. The aircraft as claimed in claim 8:
wherein said first geared member of said transmission system comprises a VCT2 stack of gears;
wherein said at least one mating geared member of said transmission system comprises at least one idler gear;
wherein said input shaft of said transmission system is a splined input shaft; and
wherein said transmission system further comprises;
a first power transfer gear rotationally engaging and movable along said splined input shaft, said first power transfer gear being dimensioned to mate with and rotationally engage said idler gear;
a direct drive gear train; and
a clutch for transferring control of said rotation from said direct drive gear train to said power transfer gear.

10. The aircraft as claimed in claim 9:
wherein said at least one idler gear of said transmission system comprises a first idler gear and a second idler gear;
wherein said first idler gear of said transmission system is dimensioned to mate with and rotationally engage said stack of gears and said first power transfer gear;
wherein said output shaft of said transmission system is a splined output shaft; and
wherein said transmission system further comprises a second power transfer gear rotationally engaging and movable along said splined input shaft and dimensioned to mate with and rotationally engage said second idler gear.

11. The aircraft as claimed in claim 8:
wherein said first geared member of said transmission system comprises a VCT cone;
wherein said input shaft of said transmission system is a splined input shaft;
wherein said at least one mating geared member of said transmission system comprises a first power transfer gear rotationally engaging and movable along said splined input shaft, said first power transfer gear being dimensioned to mate with and rotationally engage said VCT cone; and
wherein said transmission system further comprises a direct drive gear train, and a clutch for transferring control of said rotation from said direct drive gear train to said power transfer gear.

12. The aircraft as claimed in claim 11:
wherein said output shaft of said transmission system is a splined output shaft; and
wherein said at least one mating geared member of said transmission system comprises a second power transfer gear rotationally engaging and movable along said splined input shaft, said second power transfer gear being dimensioned to mate with and rotationally engage said VCT cone.

13. The aircraft as claimed in claim 8:
wherein said output shaft of said transmission system is a splined output shaft;
wherein said first geared member of said transmission system comprises a VCT2 stack of gears rotationally engaging and movable along said splined output shaft;
wherein said at least one mating geared member of said transmission system comprises a worm gear disposed upon said input shaft; and
wherein said transmission system further comprises a universal joint in communication with said splined output shaft.

14. The aircraft as claimed in claim 8:
wherein said output shaft of said transmission system is a splined output shaft;
wherein said first geared member of said transmission system comprises a VCT cone rotationally engaging and movable along said splined output shaft;
wherein said at least one mating geared member of said transmission system comprises a worm gear disposed upon said input shaft.

15. The aircraft as claimed in claim 8:
wherein said aircraft is a helicopter;
wherein said at least one rotor comprises a main rotor and a tail rotor;
wherein said at least one transmission system comprises a main rotor transmission system in rotational communication with said main rotor and a tail rotor transmission system in rotational communication with said tail rotor.

16. The aircraft as claimed in claim 15 further comprising a position control means for controlling a position of said helicopter by varying a speed of rotation of at least one of said main rotor and said tail rotor.

17. The aircraft as claimed in claim 16 wherein said position control means is adapted to control a rotational position of said helicopter by varying a speed of rotation of said tail rotor.

18. The aircraft as claimed in claim 16 wherein said position control means is adapted to control a vertical position of said helicopter by simultaneously varying a speed of rotation of said tail rotor and said main rotor

19. The aircraft as claimed in claim 16 wherein said position control means comprises an analog control for controlling a gear ratio of at least one of said tail rotor transmission and said main rotor transmission.

20. The aircraft as claimed in claim 16 wherein said position control means comprises an electronic control and a memory into which is stored an algorithm for a gear ratio of at least one of said tail rotor transmission and said main rotor transmission.
